(19) United States
(12) Patent Application Publication
(10) Pub. No.: US 2004/0100350 A1
(43) Pub. Date: May 27, 2004

(54) Adjusting device for a thermal trip element

(76) Inventor: Christoph Weber, Ergoldsbach (DE)

Correspondence Address: HARNESS, DICKEY & PIERCE, P.L.C., P.O.BOX 8910, RESTON, VA, 20195, US

(21) Appl. No.: 10/470,692

(22) PCT Filed: Jan. 18, 2002
(86) PCT No.: PCT/DE02/00155

(30) Foreign Application Priority Data
Jan. 31, 2001 (DE) 101 04 272.8

(51) Int. Cl. H01H 37/52

(52) U.S. Cl. 337/36

(57) ABSTRACT

The invention relates to an adjusting device for a thermal trip element of a switchgear (1), comprising a bimetallic element (3) that is stationarily fixed on a bimetallic support (4). The free end (3b) of said bimetallic element is spaced apart from a trip lever (6) and increasingly impinges the same in the direction of release (D) as a result of the thermal deformation, the distance (A) being adjustable by bending the bimetallic support (4). The adjusting device (4, 12 or 15) is especially suitable for circuit breakers or the like.

The invention relates to an adjusting apparatus for a thermal release of a switching device as claimed in the preamble of claim 1. An adjusting apparatus of this type is known from EP 0 913 848 A2. A switching device is understood here to mean mechanical or electromechanical switching devices, in particular power breakers, circuit breakers, relays, contactors and the like.

Such a switching device serves the purpose of connecting a circuit to an electrical power supply system and isolating the circuit manually and automatically from the supply system if the current exceeds a predetermined value. A power breaker, for example, thus serves the purpose of protecting lines in installations and systems from overload and short circuit. In a supply system having a shutdown facility using overcurrent protection devices for disconnection, such a switching device also prevents touch voltages which are too high from being maintained in the event of a fault.

When the switching device or circuit breaker is switched on, an energy store, for example a spring, is stressed as part of a mechanical switching mechanism or breaker mechanism, is released for the tripping operation and operates the switch. Here, the switching device comprises a thermal release in the form of a bimetallic element which is usually in the form of a strip and which trips with a delay depending on the overload duration. The tripping operation is initiated by thermal deformation of the bimetallic strip as a result of the overcurrent passing through it. For this purpose, the bimetallic strip acts on a tripping lever which is opposite the free end of the bimetallic strip, spaced apart from it, and is mechanically coupled to the breaker mechanism. The tripping lever thus causes the bimetallic strip to release the breaker mechanism whilst the energy store of the breaker mechanism opens a moveable contact or moving contact by lifting said contact from a fixed contact. In addition, the switching device also usually comprises a magnetic or electromagnetic release, which trips without a delay, for high surge and short-circuit currents.

The distance between the free end of the bimetallic element and the tripping lever is to be designed to be adjustable, for which purpose an adjusting screw is usually provided. Switching devices in which such an adjusting screw is used to adjust the bimetallic element are known, for example, from DE 1 904 731 A1 and from EP 0 143 981 A1 as well as from EP 0 412 953 A3. The use of an adjusting screw does, however, entail corresponding production and manufacturing costs.

EP 0 913 848 A2 also discloses a method for thermally calibrating the tripping mechanism of a switching device and a corresponding tripping mechanism, in which the adjustment is carried out thermally, by means of a laser.

The invention is therefore based on the object of proposing a particularly cost-effective adjusting apparatus, which is easy to operate, for a switching device, in particular for a power breaker.

This object is achieved according to the invention by the features of claim 1. For this purpose, the distance between the tripping lever and the free end, which acts on the tripping lever increasingly as a result of thermal deformation in the tripping direction, of the bimetallic element can be set by bending a bimetallic support which is firmly connected to the bimetallic element.

Here, the bimetallic support has at least one predetermined bending point, preferably two or three predetermined bending points. By this means, the bimetallic support acts as a multi-link chain or multi-joint mechanism when it is fixed or mounted in the enclosure of such a switching device. The bimetallic support has, in the region of a first predetermined bending point, a retaining limb, which runs parallel to the bimetallic element and is connected to its contact end, as well as an operating limb, which runs at least approximately transversely with respect to said retaining limb. The free end of the operating limb can be guided in or against an enclosure profile, this free end being guided or held, by means of a corresponding actuating tool, such that it can pivot on a bending path which is at least approximately in the form of a circular arc.

A further, second predetermined bending point is provided either along the retaining limb or on the limb end of the retaining limb which is remote from the operating limb. In this embodiment, the bimetallic support merges at this second predetermined bending point with a fixing limb which runs transversely with respect to the retaining limb, expediently at an obtuse angle. The fixing limb itself is then expediently in turn bent back twice, resulting in an overall approximately U-shaped fixing limb and thus a bimetallic support which is bent, overall, in the form of a ring or a loop.

With this configuration, which is, for example, in the form of a ring or a loop, of the bimetallic support, the operating limb which extends from the first predetermined bending point is bent inward or outward.

If the operating limb is bent outward, its end is guided against an adjustment profile in the form of an arc. This profile is preferably provided by an appropriate enclosure profile of the switching device.

This adjustment or enclosure profile which is in the form of an arc has a diminishing radius in which the operating limb lies. When the operating limb is rotated about the first predetermined bending point, forming a pivot, against the adjustment profile, the bimetallic support is bent and thus the position of the bimetallic element is changed for the purpose of adjusting the bimetallic element. Here, the transformation ratio of the angle of rotation of the operating limb to the movement of the free end of the bimetallic element can be set, depending on the requirements, by correspondingly configuring the adjustment and enclosure profile.

When the operating limb is bent inward, a further (third) predetermined bending point is expediently provided along said operating limb. A positioning pin, which runs transversely with respect to the longitudinal direction of the limb and can be fixed in position in a positioning opening, which is in a fixed position, in the enclosure of the switching device, is then integrally formed on the operating limb between this (third) predetermined bending point and the free end of the operating limb.

In this embodiment of the bimetallic support and thus of the adjusting apparatus, too, the bimetallic support is in turn bent by rotating the operating limb about the pivots formed by the two predetermined bending points, and thus the position of the bimetallic element is changed for adjustment purposes. In both embodiments, the distance between the free end of the bimetallic element or the tip of the bimetallic element and the tripping lever is thus set or adjusted by bending the bimetallic support. The predetermined bending points are expediently formed by material cutouts in the corresponding vertices of the bends in the bimetallic support.

The advantages achieved by the invention are, in particular, the fact that, by appropriately configuring and arranging a bimetallic support bearing the bimetallic element, it is possible to bend said bimetallic support specifically and thus to provide a simple and cost-effective adjusting apparatus for a thermal release of a switching device.

This mechanism, which serves the purpose of adjusting the bimetallic element and in which the bimetallic support, which is expediently provided with predetermined bending points, acts in the manner of a multi-link chain, in particular a three- or four-link chain, also makes possible virtually automatic or independent compensation for subsequent shrinkage of the enclosure. Such shrinkage, to which enclosure materials which are usually used are subject, leads, over the life of the device, to undesirable changes in important structural and dimensional proportions, such as, in particular, the distance between the tip of the bimetallic element and the tripping lever, and thus to an undesirable maladjustment or displacement of the thermal release as well.

Exemplary embodiments of the invention are explained in more detail below with reference to a drawing, in which:

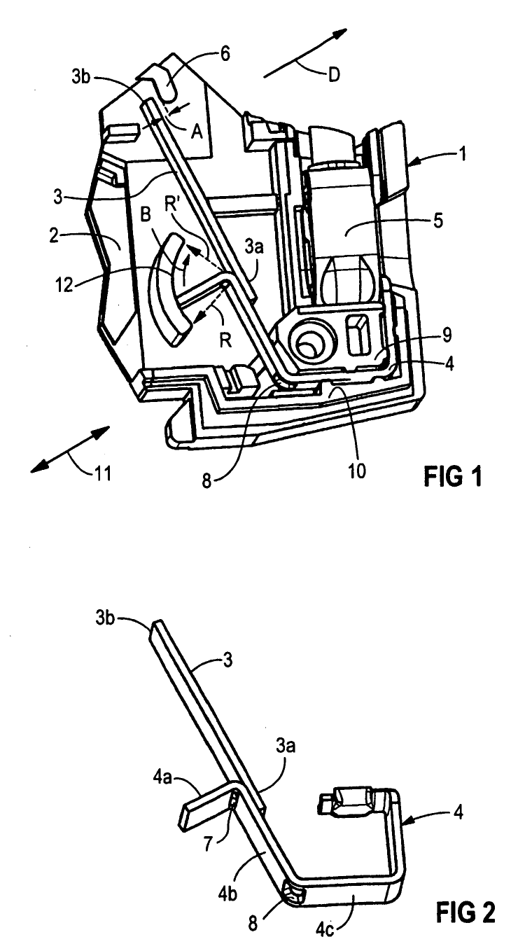

FIG. 1 shows a perspective illustration of a thermal tripping apparatus, which is mounted at the end in a switching device, with a first embodiment of an adjusting apparatus according to the invention having a bimetallic support with two predetermined bending points,

FIG. 2 shows the bimetallic support from FIG. 1 connected to a bimetallic strip,

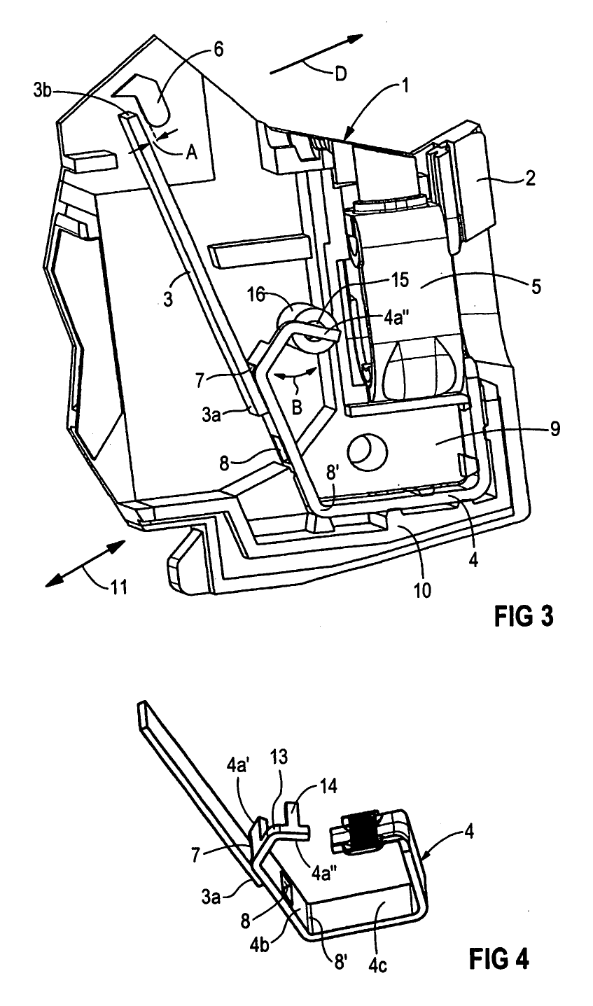

FIG. 3, in an illustration as shown in FIG. 1, shows a second embodiment of the adjusting apparatus according to the invention with a bimetallic support having three predetermined bending points, and

FIG. 4, in an illustration as shown in FIG. 2, shows the bimetallic support from FIG. 3.

Corresponding parts are given the same reference symbols in all the figures.

FIGS. 1 and 3 show details of a switching device 1 with the enclosure cover of the enclosure 2 of said switching device removed, in which the essential parts of an adjustable thermal release can be seen. The thermal release has a bimetallic strip 3, whose contact end 3a is connected, by techniques such as soldering, bonding or welding, to a bimetallic support 4 and is thus retained in a fixed position. The bimetallic support 4 is connected to a supply terminal 5 in an electrically conductive manner in order to pass current through the switching device 1.

The free end 3b of the bimetallic element 3, i.e. the tip of the bimetallic element, lies opposite a tripping lever 6, spaced apart from it, said tripping lever being coupled, in a manner known per se, to a switching mechanism or breaker mechanism, not illustrated in any further detail. This distance A between the tip 3b of the bimetallic element and the tripping lever 6 can be set by bending the bimetallic support 4.

In the embodiment of the adjustable thermal release and thus of the adjusting apparatus shown in FIGS. 1 and 2, the bimetallic support 4 is bent back twice or more in the manner of a three-link chain. In this case, an operating limb 4a and a retaining limb 4b, which runs transversely with respect to, i.e. at least approximately at right angles to, said operating limb, of the bimetallic support 4 are formed at a first predetermined bending point 7. The contact end 3a of the bimetallic element 3 is connected, by techniques such as soldering, bonding or welding, to this retaining limb 4b.

The retaining limb 4b merges, in this embodiment, with a fixing limb 4c at a second predetermined bending point 8, said fixing limb itself being bent so as to be approximately U-shaped. The bimetallic support 4 is fixed in position, by means of this fixing limb 4c, in the enclosure 2 by corresponding enclosure fittings or profiles 9, 10. Here, the retaining limb 4b can be bent both about the (second) predetermined bending point 8 and about the (first) predetermined bending point 7 in the direction of the double-headed arrow 11 and is thus enclosed in the enclosure 2, without bearing against it, over the entire length of the retaining limb.

The operating limb 4a, pointing outward, of the bimetallic support 4 is guided at the end against an enclosure profile in the form of and arc and is supported on this. This enclosure profile forms the adjustment profile 12 in the form of an arc for the purpose of adjusting the bimetallic element. The radius R of this adjustment profile 12, determining an adjustment path B in the form of a circle or circular arc, decreases in the clockwise direction to a smaller radius R′.

In order to adjust the bimetallic element and thus to set the distance A between the free end 3b of the bimetallic element 3 and the tripping lever 6, the operating limb 4a of the bimetallic support 4 is rotated, by means of an operating tool (not shown), about the pivot formed by the first predetermined bending point 7 against the adjustment profile 12, and thus the bimetallic support 4 is bent, with the result that the position of the bimetallic element 3 is correspondingly changed for the purpose of setting the distance A. Thus, when the operating limb 4a is turned in the clockwise direction, i.e. in the direction of the arrow, illustrated, of the adjustment path B, the bimetallic element 3, and thus its free end or the tip 3b of the bimetallic element, is turned in the tripping direction D. In this embodiment, the adjusting apparatus is essentially formed by the bimetallic support 4, having the bimetallic element 3 retained on it, and the adjustment profile 12.

In the embodiment of the bimetallic support 4 shown in FIGS. 3 and 4, the second predetermined bending point 8 is provided approximately in the central region of the retaining limb 4b of the bimetallic support 4. Up to this predetermined bending point 8, the bimetallic support 4 is then clamped, in a force-fitting manner, to the fixing limb 4c of this bimetallic support between the correspondingly configured enclosure fittings or profiles. Thus, only a limb section of the retaining limb 4b and, in the extension of said retaining limb over the first predetermined bending point 7, the operating limb 4′a can be bent in the direction of the double-headed arrow 11. The fixing limb 4c, which, in this embodiment, adjoins the retaining limb 4b via a bend 8′, of the bimetallic support 4 is in turn bent so as to be at least approximately U-shaped.

In this embodiment, the operating limb 4′a is bent inward and, at the same time, is itself bent back, forming a third predetermined bending point 13, with the result that the bimetallic support 4 acts in the manner of a four-link chain. The first and second predetermined bending points 7 and 8, respectively, are, in the two embodiments in FIGS. 2 and 4, formed by holes or stampings in the sheet metal material of the bimetallic support 4. In the embodiment in FIGS. 3 and 4, the third predetermined bending point 13 is expediently also produced by a corresponding material cutout.

At the free end, a pivot or positioning pin 14 is integrally formed on the operating limb 4′a and is formed by a material cutout in the operating limb 4′a, which is in the form of a sheet metal tab. By means of this pivot pin 14, the operating limb 4′a engages in an enclosure receptacle or pivot opening 15, acting as the pivot profile, which is provided in an appropriately positioned enclosure profile, expediently in the form of an enclosure structure 16 which is in the form of a dome. The actuating tool grips the free end 4″a, lying in the region of the pivot pin 14, of the operating limb 4′a, for the purpose of adjusting the bimetallic element.

In this embodiment, too, the bimetallic support 4 is in turn bent by rotating the operating limb 4′a in the direction of the double-headed arrow B, illustrated, and the position of the bimetallic element 3 is changed for the purpose of setting the distance A. Here too, when the operating limb 4a is turned in the clockwise direction of the arrow direction, illustrated, of the adjustment path B, the tip of the bimetallic element or the free end 3b of the bimetallic element 3 is turned in the tripping direction D and, by this means, the bimetallic element is adjusted. In the process, the pivot joint, formed by the pivot pin 14 and the pivot opening 15, in turn determines the adjustment path B which is in the form of a circle or circular arc and is symbolized by the double-headed arrow. Here, the adjusting apparatus is essentially formed by the bimetallic support 4, with the bimetallic element 3 held on it, and the pivot opening 15, acting as the adjustment profile, in the enclosure attachment 16.

In both embodiments, the mechanism, which serves the purpose of adjusting the bimetallic element and acts in the manner of a multi-link chain by means of the predetermined bending points 7 and 8 or 7, 8 and 13 provided along the bimetallic support 4, advantageously also compensates for any virtually unavoidable subsequent shrinkage of the enclosure. If, owing to such shrinkage of the enclosure, the position of the tripping lever 6 changes in the direction of increasing the distance A, this shrinkage also causes the enclosure profile 12, acting as the adjustment profile, or the enclosure attachment 16—and thus the pivot opening 15 acting as the adjustment profile—to move closer to the bimetallic element 3. This in turn causes the bimetallic support 4 to bend automatically and thus the bimetallic element 3 to then be readjusted toward the tripping lever 6, which is moving further away, so that the distance A remains virtually constant.

Thus, in the embodiment in FIG. 1, the distance or the dimension A increases owing to shrinkage of the enclosure. At the same time, the profile 12 moves toward the profile 9 and the bimetallic strip 3 or its tip 3b is then readjusted in the clockwise direction.

In contrast, in the embodiment in FIG. 3, the distance or the dimension A decreases as a result of shrinkage of the enclosure, the profile 16 moving toward the fixing profile 9. By this means the distance between the two predetermined bending points 8 and 13 is reduced, causing the predetermined bending point 7 to be pushed in the opposite direction to the tripping direction D and the bimetallic element 3 to be moved in the counterclockwise direction.

1. An adjusting apparatus for a thermal release of a switching device (1), having a bimetallic element (3) held in a fixed position on a bimetallic support (4), whose free end (3b) is spaced apart from a tripping lever (6) and acts on it as a result of thermal deformation increasingly in the tripping direction (D), in which case the distance (A) can be set by bending the bimetallic support (4), characterized in that the bimetallic support (4) has, in the region of a first predetermined bending point (7), a retaining limb (4b), which runs parallel to the bimetallic element (3) and is connected to the contact end (3a) of said bimetallic element, as well as an operating limb (4a), which runs approximately transversely with respect to said retaining limb, whose free end, is guided in or against an enclosure profile (12 or 15, 16), can be pivoted on an at least approximately circular adjustment path (B).

2. The adjusting apparatus as claimed in claim 1, characterized in that the bimetallic support (4) has, along its retaining limb (4b), a second predetermined bending point (8), spaced apart from the first predetermined bending point (7).

3. The adjusting apparatus as claimed in claim 1 or 2, characterized in that the bimetallic support (4) has a fixing limb (4c) which adjoins the retaining limb (4b) via a bend (8, 8′) and is at least approximately U-shaped.

4. The adjusting apparatus as claimed in one of claims 1 to 3, characterized in that the end of the operating limb (4a) of the bimetallic support (4) is guided against an adjustment profile (12) in the form of an arc.

5. The adjusting apparatus as claimed in claim 4, characterized in that the adjustment profile (12) forms an adjustment path (B) at least approximately in the form of a circular arc and having a decreasing radius (R, R′).

6. The adjusting apparatus as claimed in one of claims 1 to 3, characterized in that the operating limb (4′a) of the bimetallic support (4) has a pivot pin (14), which runs transversely with respect to the longitudinal direction of the limb and can be fixed in position in a pivot opening (15), which is in a fixed position, a further (third) predetermined bending point (13) being provided between said pivot pin and the first predetermined bending point (7).

7. The adjusting apparatus as claimed in one of claims 1 to 6, characterized in that the or each predetermined bending point (7, 8, 13) is formed by a material cutout in the respective vertex of the bend in the bimetallic support (4).

8. A switching device, in particular a power breaker, having the adjusting apparatus (4, 12 or 15) as claimed in one of claims 1 to 7.

9. The switching device as claimed in claim 8, in which the adjusting apparatus (4, 12 or 15) compensates for any shrinkage of the enclosure such that, when the distance (A) between the tripping lever (6) and the free end (3b) of the bimetallic element (3) changes, the tripping lever (5) moves automatically in a corresponding manner in the clockwise or counterclockwise direction.
